(19) United States
(12) Patent Application Publication
(10) Pub. No.: US 2006/0101523 A1
(43) Pub. Date: May 11, 2006

(54) Automatic custom interface based upon the security level of a document

(75) Inventor: Bruce E. Talbert, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/985,317

(22) Filed: Nov. 10, 2004

(51) Int. Cl. H04N 7/16

(52) U.S. Cl. 726/26

(57) ABSTRACT

A security method for a multifunctional device. The method includes receiving a document, wherein the document has an associated security level, determining what services may be used with respect to the document, based upon the security level of the document, and generating a customized user interface that does not display any services that may not be used with the document. Further, the device may receive personally identifying information from a user including the user's security level, and deciding what services may be used with respect to the document is based at least in part upon the user's security level.

### COPENDING APPLICATIONS

Cross-reference and incorporation by reference is made to U.S. application Ser. No. ______, filed on same date by Bruce E. Talbert et al (Attorney Docket No. A2193-US-NP).

The embodiments disclosed herein are directed to access control methods and more specifically to security access to people or documents.

The US government requires that any information technology (IT) device that is purchased and used in government installations be certified by the ISO-15408 (Common Criteria) standard. One component of this standard requires that IT devices be capable of limiting services to users based upon the sensitivity of the data they are processing. This is known as Mandatory Access Control (MAC) within the standard. If a product maintains a list of usernames and sensitivity labels internally, the government requires adherence to certain controls and procedures, which generally requires more engineering and development overhead. One option is to integrate this information into a user services directory to provide a mechanism for knowing what services are allowed to individual users.

Implementing these criteria leads to some engineering issues. For example, in a highly secure environment, reliance upon the user to specify the security label would not provide the proper level of assurance for that environment. Also, the Export of Labeled Data requires that the sensitivity label of a document be transported along with the document itself, in order to allow the recipient machine to process the document appropriately.

Another component of the common criteria standard requires that IT devices be capable of limiting services to users based upon their security attributes. This is known as Discretionary Access Control (DAC) within the standard. Once a system has determined what services are available to a user, the issue arises of to how to enforce the policy of only allowing a given user to use the services he has been authorized to do so.

U.S. patent applications Ser. No. 10/684,627 filed Oct. 14, 2003, DEVICE AUTHORIZATION SYSTEM USING OPTICAL SCANNER by Martin Ball (Attorney Docket No. A1547); Ser. No. 10/685,320 filed Oct. 14, 2003 METHOD AND APPARATUS FOR ACCESSING SPECIALTY FUNCTIONS OF A MARKING MACHINE by Martin Ball et al (Attorney Docket No. A1547Q); Ser. No. 10/685,109 filed Oct. 14, 2003, A METHOD AND APPARATUS FOR PRINTING CONVENIENCE IN A NETWORKED SYSTEM by Stephen D. Morris-Jones (Attorney Docket No. A3227); and Ser. No. 10/685,238 filed Oct. 14, 2003 MULTIFUNCTION DEVICE SYSTEM USING TAGS CONTAINING OUTPUT INFORMATION by Stephen D. Morris-Jones et al (Attorney Docket No. A3227Q) also deal with access controls to devices and are hereby incorporated by reference in their entirety for their teachings.

In secure environments, only users who have been granted the proper security clearance (e.g., top-secret) may handle materials of a particular classification. For multi-function devices, the challenge is to identify what classification the user has, what security level a document has been assigned and to appropriately allow or deny access to the services based upon these security levels. This information would be stored within the customer's directory service, thus would be available for the system to determine what level of classification of data the user is allowed to process.

In providing a secure environment, the security folks might also determine that certain processes (e.g., faxing) are not a secure method for transfer of top-secret data regardless of by whom they are performed. In such cases, the multifunction device could disallow certain features regardless of the user's security level. Alternatively, certain people could have access levels that are low enough that they are not allowed to perform certain processes regardless of the data being processed. In such cases, the user may be denied access to certain features regardless of the data's security level.

By modification of the customer's LDAP schema to include “Allowed Services on Xerox Multifunction Devices” as part of each user record, the storing, backup, and maintenance of user attributes is pushed into the IT environment. DIRECTORY SERVICES are a centralized repository for user information, and it is only logical to use this existing function in order to meet the DAC policies established. This requires much less engineering and development effort, (i.e. cost) for Xerox, and provides seamless integration into a customer's existing environment.

Various methods could be employed to restrict access to services disallowed for a particular user. For instance, if a user is allowed only the ability to copy, but not scan to file, one could engineer the system to disable the scan to file feature. In most cases, this would be significant engineering work, particularly with devices in which synchronization is key. This proposal is to simply provide a custom user interface that only shows the user the features he has been authorized to use. Upon authentication of the user, the system would build a custom “web site” containing only the pages the user has rights to access. It is assumed LDAP would be used to garner this information from the directory service, however the technology used is not limited to LDAP.

Embodiments include a security method for a multifunctional device. The method includes receiving a document, wherein the document has an associated security level, determining what services may be used with respect to the document, based upon the security level of the document, and generating a customized user interface that does not display any services that may not be used with the document. Further, the device may receive personally identifying information from a user including the user's security level, and deciding what services may be used with respect to the document is based at least in part upon the user's security level.

Various exemplary embodiments will be described in detail, with reference to the following figures, wherein:

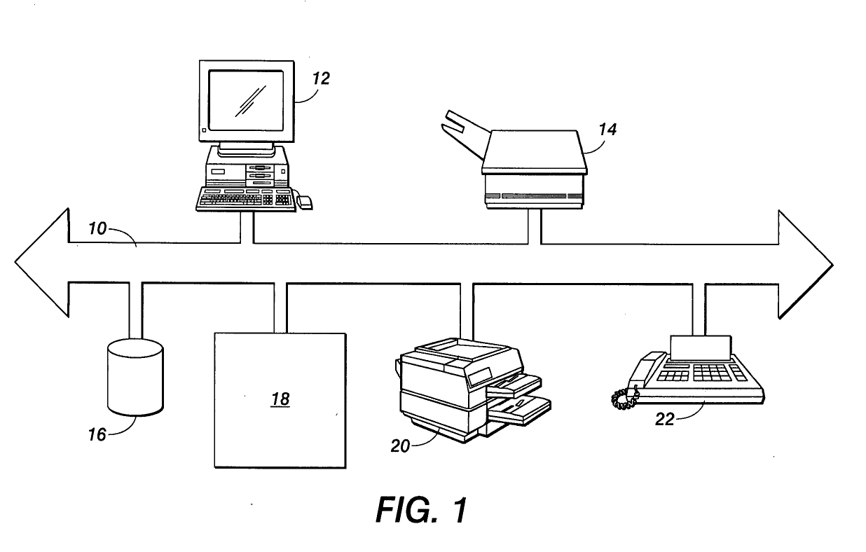

FIG. 1 is a simplified diagram showing a networked document services system.

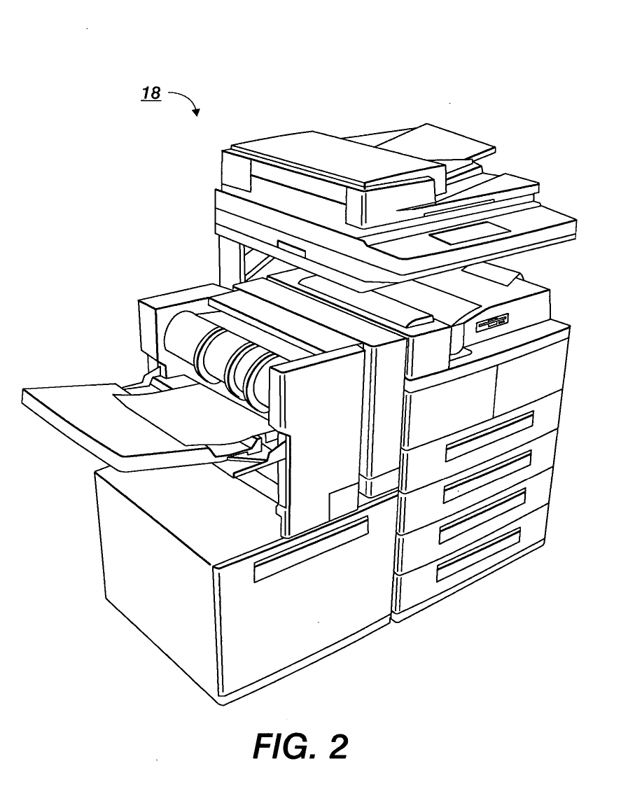

FIG. 2 illustrates an exemplary embodiment of a multi-function device.

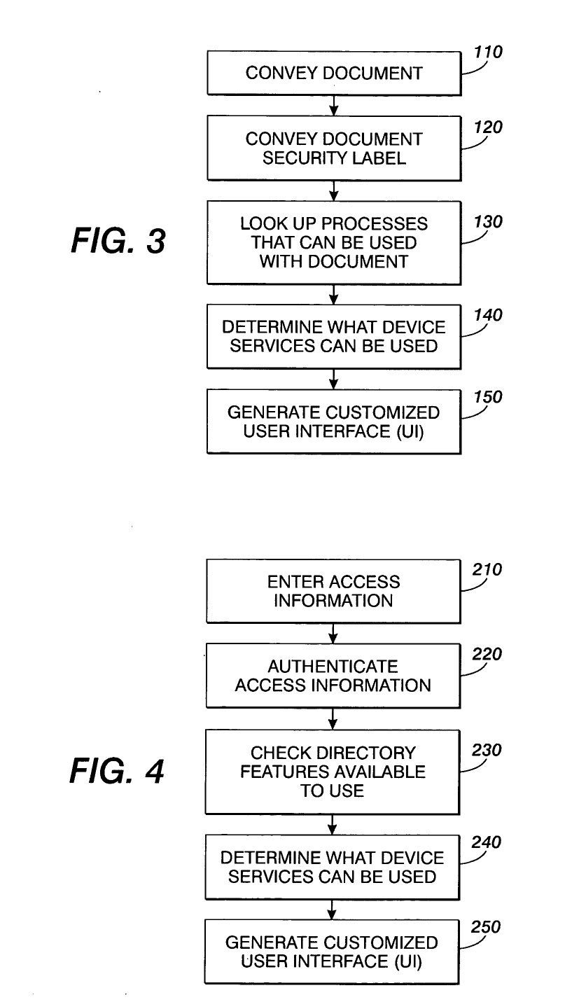

FIG. 3 is a flowchart of an embodiment of a method for using a multifunction device.

FIG. 4 is a flowchart of an embodiment of another method for using a multifunction device.

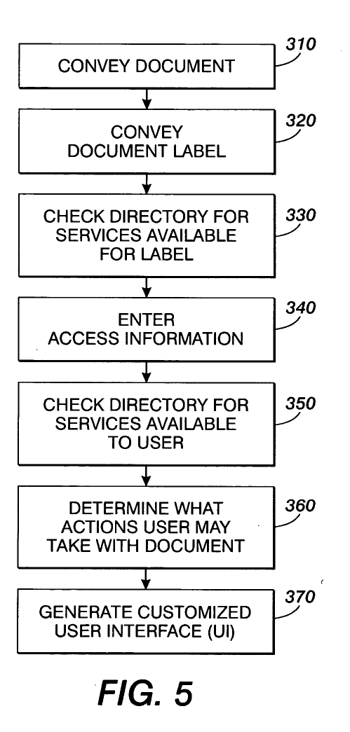

FIG. 5 is a flowchart of an embodiment of another method for using a multifunction device.

FIG. 1 is a simplified diagram showing an example of a networked document-services system in which the present invention is useful. A network bus 10, which may be of any type known in the art, such as Ethernet or Token-Ring, interconnects a number of computers and peripherals. For example, on network 10 there would be typically any number of personal or mainframe computers 12, scanners 14, shared data storage 16, and multifunction device 18. The shared memory 16 may include database information and more specifically a services directory. The multifunction device 18, such as that shown in FIG. 2 includes some combination of scanning/copying, printing, faxing, email messaging, etc. The network 10 may further interconnect individualized machines such a separate printer 20 and separate fax machine 22, which in turn connects with a standard telephone network. What is important is that the various computers and peripherals can interact to perform various document services.

In secure environments, security policy administrators will specify which users have access to a variety of internal and external features. For example, security policy administrators will specify which users have access to “internal interacting features” such as, for example, copy and print, device administration, job submission, queue management, and which users have access to “external interacting features” such as scan to email and fax. This access can be based upon a variety of criteria such as, for example, the user's security level. Those users granted access to features such as scan to email and fax pose a greater security threat to the environment because those users can transport documents outside the control of the environment. For this reason, Discretionary Access Control (DAC) policies are enacted.

This access data of people allowed to use a device will often be stored in a directory linked to the device by a network. For example, data storage 16 in FIG. 1 could include a services directory for the personnel of, for example, a secure lab or a government building. Data storage 16 is networked to multifunction device 18. In other embodiments, the directory access could be stored locally at the multifunction device itself or more remotely such as over an Internet connection. For data stored elsewhere on the network or over the Internet, the Lightweight Directory Access Protocol (LDAP) may be used. The LDAP is a commonly used protocol for querying and manipulating directory services data. The LDAP is well known to those skilled in the art of data storage and retrieval. LDAP version 2 is specified in Request for Comments (RFC) 1777, March 1995, which is hereby incorporated herein by reference. LDAP version 3 is specified in RFC 2251, (Copyright 1997 by The Internet Society), which is also hereby incorporated herein by reference. (RFCs are Internet publications that constitute the principal means by which standards are promulgated.)

People access multifunction devices through myriad methods. For example, they may use a keyboard and/or mouse. They may also wear a tag or a badge that is read in some manner (optically, electromagnetically, etc.) by a multifunction device or by a remote device connected to the multifunction device. Another exemplary method of supplying information is through biometrics (e.g., fingerprints, retinal scans, etc.)

One method for controlling user access to particular features includes presenting the user with a custom local user interface that displays only those features to which the user has been granted access once the user has supplied his access information. In place of displaying all the pages, a more efficient workflow could be provided by displaying a custom set of web pages that are comprised of only those services to which the user is allowed to access. The device determines which features the user may access, for example, by checking the user's profile kept internally or remotely and creates a user interface tailored to that user. In embodiments, the primary basis for creating the interface would be the user's security level. DAC policies restricting access to particular features could be enforced simply by not displaying unauthorized features to the user. Complete disablement of the service would not be necessary, nor would the re-enablement of the service once an allowed user attempts to access it.

The first phase of this process is to modify the customer's schema in the directory service. A field would be added to each user's record that would be entitled “Allowed Xerox Document Centre Services,” and would be populated with the values the security professionals deemed necessary for each user. For instance, a multifunction device may offer print, copy, analog fax, LAN fax, scan to file, and scan to email services to users. Therefore, for user “John Doe,” it might be necessary to allow him to print, copy and scan to file, but not send analog or LAN fax jobs, or scan to email jobs. In the “Allowed Services” field, the values would be “Print,” “Copy,” and “Scan to File.” The allowed services field may be based wholly upon the user's information or may be based in part upon the document (discussed elsewhere) or the device being used. For example, whether the device being used was in a public or private location may affect the user's options.

The second phase of this process begins with user authentication at the device local user interface, the web user interface, or the print driver. The user first enters login information (be it username/password, fingerprint, etc.), which is then authenticated. Upon successful authentication, the device queries the “Allowed Services” field of the customer's directory services directory and only allows the services specified to be used by the user.

Documents or other data can be security rated as well. Often an organization may want to limit what actions may be taken with a particular document. For example, physical control may be taken by applying a radio-frequency tag to the document so that its location can be controlled. It may also be desired (or required by policy or law) to control what is done to the document. This is known as Mandatory Access Control (MAC). In embodiments a sensitivity or security label may be “attached” to the document. For example, the label may be attached literally or be encoded onto the front of a physical document. Scannable bar codes or glyphs are two methods of including this information on the document. Optical Character Recognition technology may also be used to read labels comprised of normal print. (In government installations, there are specific requirements relating to the location of the label. This makes it easier to separate the label from the content.) The security label may also be attached to an electronic document such as by being included in the metadata of the document. The term security label will be used generally to refer to physical as well as electronic labels.

The data linking possible actions to the security label of a document can also be located locally or remotely over a network or the Internet. For example, the security label information could be stored locally at the multifunction device itself. In other embodiments, data storage 16, which is networked to multifunction device 18, could include a services directory that includes information regarding various document classifications including security classifications. The data could also be stored more remotely, such as over an Internet connection. Again, for data stored elsewhere on the network or over the Internet, the Lightweight Directory Access Protocol (LDAP) may be used. If a directory services database is used, the directory schema may include a defined field limiting what actions may be taken when a document has a particular security label attached to it.

A document would be conveyed to a device such as the multifunction device 18. The document would contain a label that included security information about the document. In embodiments, a security label classifies the content of the document into categories, such as “Public,” “Confidentia,” “Top Secret,” etc. A user interface would then be generated that did not include features such as fax or email that should not be used with the document. In place of displaying all the pages, a more efficient workflow could be provided by displaying a custom set of web pages that are comprised of only those services that may be used with the document. The device determines which features may be used by, for example, checking the security label information kept internally or remotely and creating a user interface tailored for that document. In embodiments, the primary basis for creating the interface would be the document's security level. MAC policies restricting access to particular features could be enforced simply by not displaying unauthorized features to the user.

The customized user interface presented to the user could also be based upon both the user's security rating and the document's security label. The user's security level may define the security level of the documents he may possess or manipulate. In embodiments, the user would provide his access information and convey a document to a multifunction device (these steps could be performed in either order. The system queries an information directory (local to the device or remote on a network or over the internet) to determine what labels of data the user can process. The information directory would return the information related to the security levels of both the user of a multifunction device and the document that the user is attempting to process. Specifically, this information would indicate what sensitivity label(s) the user could process and how that user may process it. In embodiments, the user would then be presented with a customized user interface that would exclude features that available to the user for that document.

For example: a user is attempting to fax a document that is labeled “Top Secret.” He authenticates successfully and, based upon the site rules, it has been determined that that particular user can fax data, but is only authorized to handle “Public” data. Upon initiation of the fax job, the system, while scanning the document, examines the pre-defined area containing the sensitivity label, determines the document is Top Secret. This determination is validated against the information received from the directory service, which did not state the authenticated user was allowed to process Top Secret data. The system could then simply not fax the job, and notify the user that he was attempting to perform an unauthorized action. Alternatively, a fax option may never be presented to the user.

In addition to external transmission of documents, there may be concern over internal transmission. Certain machines might be located in a public area, and therefore it would not be prudent for them to receive Top Secret data. After conveying the document to a device, the user may be presented with a customized UI that does not include devices located in public locations. Alternatively, if the user was indeed authorized to fax top secret data, and the sending machine processed the job, the sensitivity label would be transmitted with the data. Assuming the top secret document got faxed to a machine located in a public area, the receiving machine would also receive the security label and the receiving machine could refuse to print the job.

In embodiments, the systems administrator would, based upon a determination of which services on the device are capable of handling secure transmission, map the services to sensitivity labels (levels of classification). For example, the following classification scheme may be used: “Public” documents may be faxed, copied, scanned to Email, scanned to file, printed, or IFAXed; documents labeled “Private” may be copied, scanned to email, scanned to file, printed, or IFAXed; “Classified” documents may be copied, scanned to file, or printed; and “Top Secret” documents may only be copied or printed. The preceding was just one example of a classification scheme and not intended to be limiting.

After the labels to services have been mapped, a user would approach the system (either locally or remotely) and be prompted for authentication. After obtaining the username and password, the system would authenticate the user and/or prompt the user for what sensitivity label is assigned to the data he is wishing to print, copy, etc. (In most Government installations, the security model is based upon the assumption for the general office that the users will not maliciously attempt to abuse data or privileges.) For example, say the user entered “Top Secret.” The system would query the directory service to do two things: a) validate the user has privileges to handle “Top Secret” data, and b) if so, present the user with the Copy and Print options only. If the user is not authorized to process “Top Secret” data, he will be appropriately notified.

Another example would be a user attempting to Fax a document that is labeled “Top Secret.” He authenticates successfully, and, based upon the site rules, it has been determined that that particular user can Fax data, but is only authorized to handle “Public” data. Upon initiation of the Fax job, the system, while scanning the document, examines the pre-defined area containing the sensitivity label and determines the document is Top Secret. This determination is validated against the information received from the directory service, which did not state the authenticated user was allowed to process Top Secret data. The system would then not fax the job, and notify the user that he was attempting to perform and unauthorized action.

FIG. 3 is a flowchart describing a process based upon a document's security level. First a document is conveyed 110 to a multifunction device 18. The security label associated with the document is also conveyed 120 to the device. Steps 110 and 120 will typically be performed by the same act of either scanning or electronic submission from elsewhere. The next step involves looking up 130 the features available to use with a document having that security label. This can be done by either querying a local directory or a directory connected to the device 18 through a network or the Internet. Next, the device determines 140 what services or features (if any) that it offers are available for use with that document. The device then generates 150 a customized user interface for use with the document that only includes services or features that may be used with the document. The customized user interface may be the device user interface itself or a remote user interface through a network.

FIG. 4 is a flowchart describing a process based upon a user's security level. First a user enters 210 access information into a device. This can involve, for example, typing in a username and password, scanning a tag or badge, or entering biometric information. The device receives the user's data and authenticates 220 that data. The next step involves looking up 230 the features available to that user. Typically, the user's access privileges will be based upon the user's security profile. However, access privileges may be based upon other criteria as well. This can be done by either querying a local directory or a directory connected to the device 18 through a network or the Internet. Next, the device determines 240 what services or features (if any) that it offers are available to that user. The device then generates 250 a customized user interface for the user. The customized user interface may be the device user interface itself or a remote user interface through a network.

FIG. 5 shows a third embodiment that combines features of the first two. First a document is conveyed 310 to a multifunction device 18. The security label associated with the document is also conveyed 320 to the device either. These can be conveyed simultaneously or in either order. In embodiments, the device checks 330 a directory for services available for a document. A user also enters 340 access information into a device. The user data may be entered before, during, or after the document and security label. In embodiments, the device checks 350 a directory for services available to the user, which are typically, but not always based upon the user's security profile. Steps 330 and 350 may be performed as one step or simultaneously. The multifunction device 18 then determines 360 what actions a user may take with a particular document. Finally, the device then generates 370 a customized user interface for the user. The customized user interface may be the device user interface itself or a remote user interface through a network.

In the preceding paragraphs, the device was referred to as determining what services or features were available to the user and also as generating the user interface. Of course, the processing required to determine what device features were available to the user and to generate the user interface may be accomplished by any processor connected to the device through a network.

People access multifunction devices such as device 18 both directly at the device and indirectly through remote network or Internet connections. The custom user interface generated in the preceding embodiments could be displayed on the device itself or alternatively, displayed through a network or the web to a remote user.

While the present invention has been described with reference to specific embodiments thereof, it will be understood that it is not intended to limit the invention to these embodiments. It is intended to encompass alternatives, modifications, and equivalents, including substantial equivalents, similar equivalents, and the like, as may be included within the spirit and scope of the invention. All patent applications, patents and other publications cited herein are incorporated by reference in their entirety.

What is claimed is:

1. A security method for a multifunctional device, comprising:
receiving a document;
determining what services may be used with respect to the document;
generating a customized user interface that does not display any services that may not be used with the document.

2. The method of claim 1, wherein the document has a security level associated with it and wherein determining what services may be used with the document is based at least in part upon the document's security level.

3. The method of claim 2, wherein the document security level is determined locally at the multifunction device.

4. The method of claim 2. wherein an original version of the received document includes a security label, which when scanned is used to determine the document's security level.

5. The method of claim 4, wherein the document's security level is determined locally from information in a local database.

6. The method of claim 4, wherein the original version is scanned locally at the multifunctional device.

7. The method of claim 4, wherein the original version is scanned remotely and is received through a network.

8. The method of claim 4, wherein the security label contains information in the form of a bar code.

9. The method of claim 4, wherein the security label contains information in the form of glyphs.

10. The method of claim 1, wherein the interface generated is a web interface.

11. The method of claim 1, wherein the interface generated is a device user interface.

12. The method of claim 2, wherein determining what services may be used with respect to the document includes contacting a remote directory and retrieving an access information corresponding to the document's security level.

13. The method of claim 12, wherein the directory is accessed using a lightweight directory access protocol.

14. The method of claim 2, further comprising
receiving personally identifying information from a user including the user's security level, and
determining what services may be used with respect to the document is in part based upon the user's security level.

15. A security method for a multifunctional device, comprising:
receiving a document, having an associated security label;
contacting a directory;
receiving security level information about the document from the database;
determining what services may be used with respect to the document, based upon the security level of the document;
generating a customized user interface that does not display any services that may not be used with the document.

16. The method of claim 15, wherein the directory is contacted using a lightweight directory access protocol.

17. A method for using a multifunctional device, comprising:
conveying a document to a multifunction device;
receiving a customized user interface based upon a security level of the document.

18. The method of claim 17, wherein the customized user interface does not display any services that cannot be used with the document.

19. The method of claim 17, wherein conveying a document includes scanning it into storage, where it can be accessed through a network that includes the multifunctional device.

20. The method of claim 17, wherein conveying a document includes scanning the document at the device.

21. The method of claim 20, wherein the document contains security information in the form of a bar code.

22. The method of claim 20, wherein the document contains security information in the form of glyphs.

23. The method of claim 17, wherein the interface received is a web interface.

24. The method of claim 17, wherein the interface received is a device user interface.

25. The method of claim 17, further comprising
entering login information to access the multifunctional device,
wherein the customized user interface is based in part upon the security level associated with the login information.

26. The method of claim 25, wherein the security level associated with the login information is obtained from a remote directory.

27. The method of claim 26, wherein the directory is accessed using a lightweight directory access protocol.
